(19) United States
(12) Patent Application Publication
(10) Pub. No.: US 2015/0209635 A1
(43) Pub. Date: Jul. 30, 2015

(54) Tamper Evident Detection Device

(71) Applicants: Daniel Silvain, Tucson, AZ (US); William Rodger Gateley, Chandler, AZ (US); Douglas Paul Miller, Phoenix, AZ (US)

(72) Inventors: Daniel Silvain, Tucson, AZ (US); William Rodger Gateley, Chandler, AZ (US); Douglas Paul Miller, Phoenix, AZ (US)

(21) Appl. No.: 14/605,299

(22) Filed: Jan. 26, 2015

Related U.S. Application Data
(60) Provisional application No. 61/965,224, filed on Jan. 27, 2014.

(51) Int. Cl. A63B 59/00; A63B 71/06; G08B 13/24; A63B 59/06

(52) U.S. Cl. CPC A63B 59/0074; A63B 59/06; A63B 71/06; G08B 13/2434

(57) ABSTRACT

A device for detection of tampering with the interior of sports implements or other hollow opaque objects. The device is inserted in the interior of the object and includes an RFID tag with supporting microcircuitry for transmission of a signal. The signal can be detected outside of the device. Persistence of the signal indicates that the body of the object has not been breached or otherwise adulterated. The microcircuitry includes a kill switch that terminates the signal when the interior of the object has been compromised. Inability to detect a signal indicates tampering of the object. The device enables quick and easy screening of objects for compliance with rules or performance standards.

### BACKGROUND

A persistent problem in competitive sports is the motivation (or temptation) to modify the equipment used, in order to gain an advantage over one's rivals. To some extent, every player “customizes” his tools to make them perform better for him, or easier to use, and indeed, it is a natural thing for any workman who uses tools to do this. A certain amount of modification is usually permitted by those who oversee contests. In some cases, a modification is beneficial to all persons involved; for example, the limited use of pine tar on wooden baseball bats, to prevent hand slippage, may also prevent the batter from losing his grip and injuring persons situated nearby.

Many modifications have detrimental or even pernicious effects, however, and are limited or banned by the entities empowered to set or enforce rules and standards for the relevant sport. When infractions of the rules and standards can be carried out in a manner that escapes the notice of the enforcer, they become intolerable in a variety of ways. Specifically, when equipment modification, popularly referred to as “doctoring”, is deployable in such a manner that it is not detectable, other than by destructive testing or use of expensive, cumbersome monitoring equipment, then the problem is made worse. A short, but by no means exhaustive list of harms caused by doctoring are:
1. Inequity: the presence of a banned implement confers an advantage that is detrimental to the value of sporting in which equipment parity is assumed;
2. Immorality: sporting is ideally carried out in an environment in which “cheating” does not occur and is not encouraged;
3. Risk to health and safety: using metal and composite baseball bats as an example, the speed at which a struck ball recoils from a thinned bat barrel can be so much higher than what the same batter would have produced using a legal bat, that it endangers defensive players using fields whose dimensions are essential to the design of the game. I.e., since playing spaces are dimensionally designed to match the capabilities of human players (strength, speed, reaction times, etc.); changes to one parameter upsets the balance that makes the sport safe and viable.
4. Devaluation of sport: The use of grossly unfair advantage, especially in secrecy, vitiates the value of competition and record setting. Suspicion of rampant cheating, frequent substantial rule changes to accommodate major equipment enhancements, etc., make a sport far less enjoyable to play, and less interesting to watch.

In softball and amateur baseball, the introduction of aluminum bats, and later carbon composite bats, as technological improvements over wooden bats, required the design of the bat to have a hollow cross-sectional structure to make the bat light enough to use. Further, efficient methods of manufacture of hollow bats required modular assembly, instead of bulk milling from a solid stock piece. The higher elastic modulus of aluminum and carbon composites relative to wood, combined with a bat barrel's tubular shape, can significantly increase momentum transfer to a ball. Thus, in order to maintain the integrity of the sport, the new bats were subjected to performance standards. Most importantly, a rule specifying the bat performance standard (BPF) was enacted. Thinning or “shaving” the inner wall of a bat, or loading the end cap with additional weight, significantly increases the bat performance and nullifies the certification of the bat under the bat performance standard. At the point of manufacture the bat is considered a sealed system.

Actual enforcement of the bat specification, including but not limited to thinning of the bat walls or adding additional weight to the end cap, is difficult in practice and cheating is too easily accomplished. Firstly, for a knowledgeable practitioner, it is fairly simple to (1) remove the plastic end cap of a bat, (2) increase the I.D. of the desired part of the barrel using milling machinery, and (3) replace and re-bond the cap. If the cap is not salvageable after removal, a replacement cap is substituted. Secondly, effective screening should be 100% sampling, non-destructive, and point of use (POU).

Simple POU screening methods are generally impractical. Removal of the end cap and inspection of a suspect bat is complicated, slow and at least temporarily destructive. At best, POU screening could only be done by sparse, random sampling. Precision weighing, if practicable, would be unreliable, because weight change produced by the amount of milling needed would be within the weight variability of bat models. Methods of looking “inside” non-destructively, such as X-ray and acoustical analysis, are awkward and expensive. Additionally removal of the end cap, even for purposes of inspection to insure compliance with bat specifications, nullifies the manufacturer's certification.

The deployment of simple unencrypted electronic, optical or mechanical sensors, with kill switches, have fairly straightforward countermeasures; chips and RFID tags, for example, can in general be substituted, reverse-engineered, “spoofed” with counterfeits, etc.

An inexpensive, simple, fail-safe methodology to screen all personal sports implements of certain categories, at point of use, is needed to maintain the integrity of official sports games without disrupting the flow of games, and without adopting the kind of sweeping rule changes that preclude either technological advances or enjoyment of the sports.

### SUMMARY

The present disclosure provides a device for detection of tampering with the interior of sports implements or other hollow opaque objects. The device is inserted in the interior of the object and includes an RFID tag with supporting microcircuitry for transmission of a signal. The signal can be detected outside of the device. The signal may be activated by an interrogating signal supplied from a source located outside of the device. Persistence or detection of the signal indicates that the body or interior of the object has not been breached or otherwise adulterated. The microcircuitry includes a kill switch that terminates the signal when the interior of the object has been compromised. Inability to detect a signal indicates tampering of the object. The device enables quick and easy screening of objects for compliance with rules or performance standards

The present disclosure extends to:
A sports implement comprising:

a body having an internal cavity; and

a signal transmitting device positioned within said internal cavity.

The present disclosure extends to:
A method of detecting tampering of a sports implement comprising:

providing a sports implement, said sports implement including a body having an internal cavity and a signal transmitting device positioned within said internal cavity; and

searching for a signal from said signal transmitting device.

The present disclosure extends to:
A method of modifying a sports implement comprising:

providing a sports implement, said sports implement including an internal cavity; and

placing a signal transmitting device in said internal cavity.

### BRIEF DESCRIPTION OF THE DRAWINGS

FIG. 1 is a scale drawing of an aluminum softball bat.

FIG. 2 shows a plastic cap that has been extracted from a hollow bat barrel, and inverted to show its reinforcing structure.

FIG. 3 shows a schematic drawing of the end part of a hollow baseball or softball bat that shows an assembled end cap, an extracted cap, and an inverted cap with references.

FIG. 4 shows a schematic of two views of an inverted end cap with an added center post according to one embodiment of the present invention.

FIG. 5 shows a schematic of an elastomer fixture, and two views of an inverted end cap with the fixture used as a substrate for an added microchip, assembled into the end cap, according one embodiment of the present invention.

FIG. 6 shows a schematic of two views of the embodiment shown in FIG. 5, with a second fixture similar to that of FIG. 5 added to the end cap.

FIG. 7 shows an RFID device that is used in one embodiment of the present invention.

FIG. 8 shows a bat with end cap removed.

FIGS. 9a, 9b and 9c show various views of the RFID device of FIG. 7 during and after attachment to the end cap of a bat.

FIG. 10 shows insertion of an RFID device in a bat and reassembly of the end cap in the bat.

FIGS. 11a, 11b, and 11c show X-ray images of reassembled bats illustrating the position of the RFID devices in the interior of the bat.

### DETAILED DESCRIPTION OF THE ILLUSTRATED EMBODIMENTS

The present invention is a system that detects evidence of tampering of sealed sports implements (e.g. baseball bats, golf clubs, polo sticks, bike frames, poles, sticks, javelins) by remote communication between a handheld device and a device incorporated into the sports implement during its manufacture. The system is non-destructive. Further, the system is capable of screening each and every implement at its point-of-use (POU), and of rendering an accurate determination between acceptability or disqualification of the implement for official play. Further, the system is objective and proactive: rejection only implies non-compliance, and does not surmise by what history or means the implement became non-compliant; its use avoids the complications of discovery of malfeasance after the fact, whether intentional or not.

The present invention is comprised of a transmitting device placed inside the sports implement during its manufacture and a remote device capable of reading or interrogating the transmitting device. The embedded transmitting device communicates to the remote device at least two types of information: (1) a code signal that verifies its identity or provenance, which must match to a non-counterfeitable serialization system used by conforming manufacturers, and (2) a signal (or lack thereof) that reveals whether the implement has been compromised in a way that would make illegal tampering possible.

The system of the present invention may further include an official standard, under which any sports implement of a particular type (e.g., a softball bat) that does not include an embedded compliance device of the present invention (either from the point of original manufacture or by an officially approved and supervised retrofitting process) is systematically disqualified from official play.

The remainder of this description is of a specific illustrative embodiment of the system described hereinabove, and is not meant to be exclusive or otherwise limiting of other embodiments covered by the claims listed hereinafter.

In a preferred embodiment, the embedded transmitting device consists of an encrypted microchip and a microstrip antenna and transceiver circuit (collectively referred to herein as an “RFID tag”). The microchip and RFID tag may be a single integrated body or sectioned to come apart if pulled from the sealed system. The device may be assembled into the plastic end cap of a hollow aluminum or composite bat used for softball or amateur baseball. The RFID tag may be an active type (transmitting a signal upon interrogation) or a passive type (reflecting the interrogating signal in accordance with a code specific to its geometric structure.) An active device might be equipped with an on-board power source (e.g. long life or remotely rechargeable battery), as is commonly integrated into many programmable or “writeable” electronic chips today. On the other hand, many RFID devices today are capable of performing active functions using current that is induced in them by reception of an interrogating signal from a powered remote device.

In a further embodiment, the RFID tag and microchip circuit are further equipped with a “kill switch” to provide evidence of tampering. The kill switch may be a trigger that either prevents the embedded device from further operating, or a “write-once” signal that changes a binary logical state in the microchip that is readable remotely, along with the device's identity, as a small code extension.

In another embodiment, the on-board powered microchip can be provisioned with a variety of useful applications, such as the capability to sense and record data pertaining to use. Recorded and stored information can be accessed remotely via the RFID antenna, or in the case of a kill switch that precludes further transmission, stored information can be retrieved after removing the chip from a compromised bat.

In one embodiment, the kill switch would be actuated by physical displacement of the end cap from the barrel, or partial removal (such as by coring the end cap). With adequate RFID tag encryption, personalization, and chip design, the embedded device would not be reprogrammable or resettable, and “spoofing” would also be extremely impractical. The actuation must be coarse enough to avoid spurious triggering, such as by ordinary trauma to the bat. Removal of the cap, or part of it, is a large scale displacement, relative to the barrel, that is easily distinguishable from normal bat use. Further, simple enhancements to the microchip design (such as a timer) could delay kill switch actuation so as to be far outside the time scale of impact vibrations.

The kill switch actuation may in general be dependent on the integrity or time continuity of the RFID/load impedance matching. Wires that connect the antenna to the barrel, if broken or moved sufficiently, can perturb the matching. Alternatively, an antenna can be partially loaded by nearby objects, the removal of which changes its load impedance. In the context of the present invention, a bat barrel would be a non-contact capacitive load element for a suitably designed RFID tag, similar to the radome in some military radars. Coarse movement of the barrel relative to the tag would be a sufficiently discernible change to use for triggering.

In a related embodiment, the remote device may be implemented as a simple cellular telephone application, which can be made available as a downloadable option to umpires and referees, and would make procurement of specialized interrogation devices optional.

The embodiments may include an assemblage that secures the embedded device to the plastic end cap of a bat to provide adequate vibration isolation to sensitive parts. Typically, end caps are designed to absorb mechanical impulse shock strain in their designs; the vibration modes of a rigid cylinder may be nulled or nearly nulled at the cap's hub, because of the bat's symmetry. Thus the safest place to bond the assemblage is at the hub.

In one embodiment, the sports implement includes a body having an internal cavity and a signal transmitting device positioned within the internal cavity. The internal cavity may be positioned near an end of the sports implement. The body may include a wall having an internal surface that forms a boundary of the internal cavity. The wall or internal surface thereof may partially or fully enclose the internal cavity and may be constructed of a metal (e.g. aluminum) or composite (e.g. carbon composite, graphite) material. A signal transmitting device may be attached to the wall, internal surface of the wall, the surface of the wall lining the internal cavity, or in another position within the internal cavity. The signal transmitting device may include a signal transmitter that provides a continuous or persistent signal. Alternatively, the signal transmitting device may provide or alter a signal when prompted by a signal originating from a source outside of the internal cavity. A signal originating from a source outside the internal cavity may be referred to herein as an interrogating signal. The interrogating signal may activate or otherwise alter the signal transmitting device to prompt it to initiate or modify a signal. The signal may pass through a boundary of the internal cavity and may be received by an external detector. The signal transmitting device may include an RFID tag. The RFID tag may provide a signal for detection by the external detector. The signal transmitting device may include a kill switch. The kill switch may be configured to deactivate or render inoperable the signal transmitting device when the body is opened or the internal cavity is otherwise breached or compromised.

In one embodiment, the signal transmitting device is positioned on a polymer substrate. The polymer substrate may be attached to a boundary of the internal cavity. The signal transmitting device may include an antenna. The signal transmitting device may include a microchip for activating the signal transmitting device, producing a signal from the signal transmitting device, storing information identifying the sports implement, the state or condition of the sports implement, or describing the manufacture or date of the sports implement.

In one embodiment the sports implement is a bat. The bat may be a baseball bat or softball bat. The bat may have an end cap and the end cap may form a boundary of the internal cavity. The signal transmitting device may be attached to the end cap.

In one embodiment, the body of the sports implement has an unadulterated state and an adulterated state, where the unadulterated state is established at the time of manufacture of the body, where the signal transmitting device is operable and transmits a continuous or activated signal when the body of the sports implement is in the unadulterated state, and where the adulterated state is formed from the unadulterated state upon breach of the internal cavity of the body of the sports implement, and where the signal transmitting device is inoperable, deactivated, or incapable of transmitting a signal when the body is in the adulterated state. In one embodiment, the internal cavity is breached when matter is added or removed from the internal cavity. In another embodiment the internal cavity is breached when the weight or composition of the sports implement is altered.

The present disclosure further encompasses methods. The methods include methods of fabricating or modifying sports implements to include signal transmitting devices for detecting breach, tampering or other modification of the internal cavity of the sports implement. In another embodiment, the methods include methods for detecting the state or condition of a signal transmitting device to, for example, determine whether the internal cavity has been breached, tampered with or otherwise modified.

In one embodiment, the method is a method of detecting tampering of a sports implement that includes providing a sports implement having a body with an internal cavity and a signal transmitting device positioned within said internal cavity and searching for a signal from said signal transmitting device. The method may include providing an interrogating signal from an external source, where the interrogating signal enters the internal cavity and activates or modifies the signal transmitting device to initiate or modify a signal. The signal from the signal transmitting device exits the internal cavity and may be detected externally. The information content of the signal, or absence of a signal, may be used to classify the sports instrument or the state thereof. States of the sports instrument may include an unadulterated state having an unmodified internal cavity and an adulterated state having a breached or otherwise modified internal cavity. The state or condition of the sports implement may be used to determine whether the sports implement is compliant with the rules of the sport in which the sports implement is intended for use.

In another embodiment, the method is a method of detecting tampering of a sports implement that includes providing a sports implement having a body with an internal cavity and a signal transmitting device positioned within said internal cavity and supplying an interrogating signal to the signal transmitting device.

In still another embodiment, the method is a method of modifying a sports implement that includes providing a sports implement having an internal cavity and placing a signal transmitting device in the internal cavity. Placing the signal transmitting device may include exposing (e.g. penetrating, piercing, opening) the internal cavity.

In the embodiment in which the sports implement is a baseball bat or softball bat having an end cap, placing the signal transmitting device in the internal cavity may include removing the end cap and attaching the signal transmitting device to the end cap or elsewhere within the internal cavity.

The drawings illustrate an embodiment in which the sports implement is a hollow aluminum or composite bats used in softball and amateur baseball. Such limitation is for purposes of exemplary illustration only, and is not intended to exclude applications of the invention to other kinds of sports implements, or other applications outside the realm of sports.

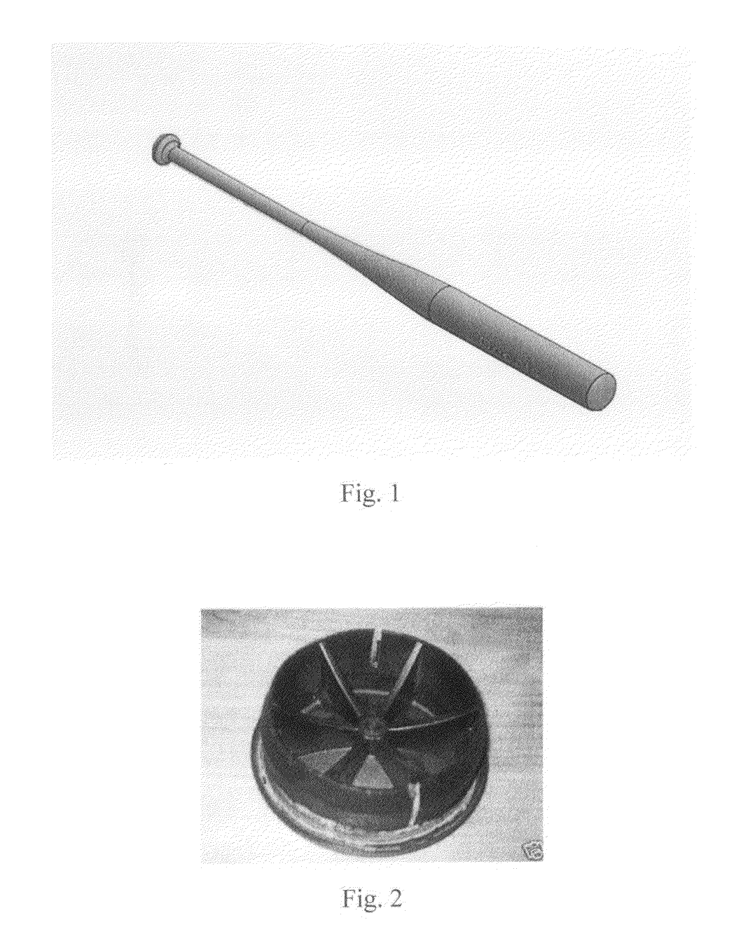

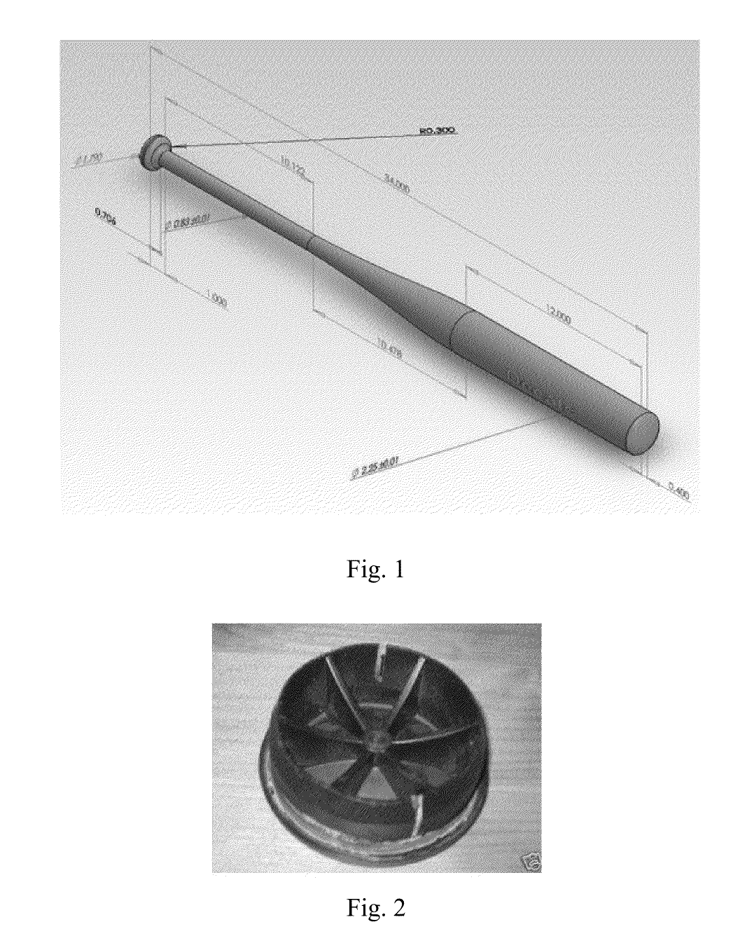

In FIG. 1, a scale drawing of a typical aluminum bat used in adult softball is shown. The barrel is hollow, and its end is stabilized by a tight-fitting plastic cap with a glued flange.

FIG. 2 is an image showing the interior reinforcing structure of an end cap, as well as a bead of adhesive along its flange, where the cap is to be bonded to the rim of the barrel. The reinforcing structure consists of a plastic central post (hub) and six plastic ribs that extend from the inner sleeve of the cap to the hub. The top of the hub is below the rim plane of the inner sleeve, so that the ribs slope down from the sleeve to the hub. The entire cap and its reinforcing structure may be cast or machined from the same plastic stock piece.

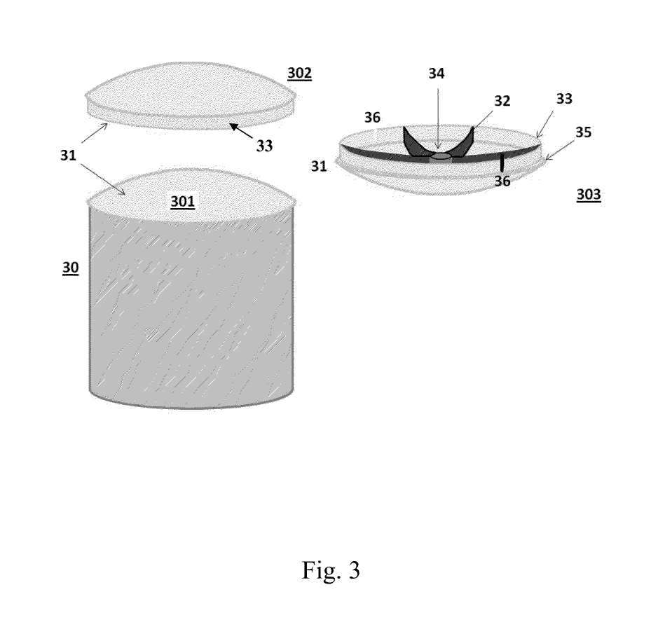

In FIG. 3, the embodiment of FIG. 2 of the present invention is depicted schematically, for clarity, wherein the plastic end cap is shown in three different positions. In view 301, end cap 31 is shown assembled with bat barrel section 30. In view 302, the end cap 31 is shown by itself after being extracted from the bat. View 302 also shows the inner sleeve 33 of the end cap, which previously fit tightly inside the barrel 30. View 303 shows the cap flipped over to reveal its interior. The reinforcement struts 32 extend from the inner sleeve 33 to the hub 34. Relief slots 36 for the inner sleeve extend from its rim to the flange 35, and facilitate the insertion of the end cap into the barrel.

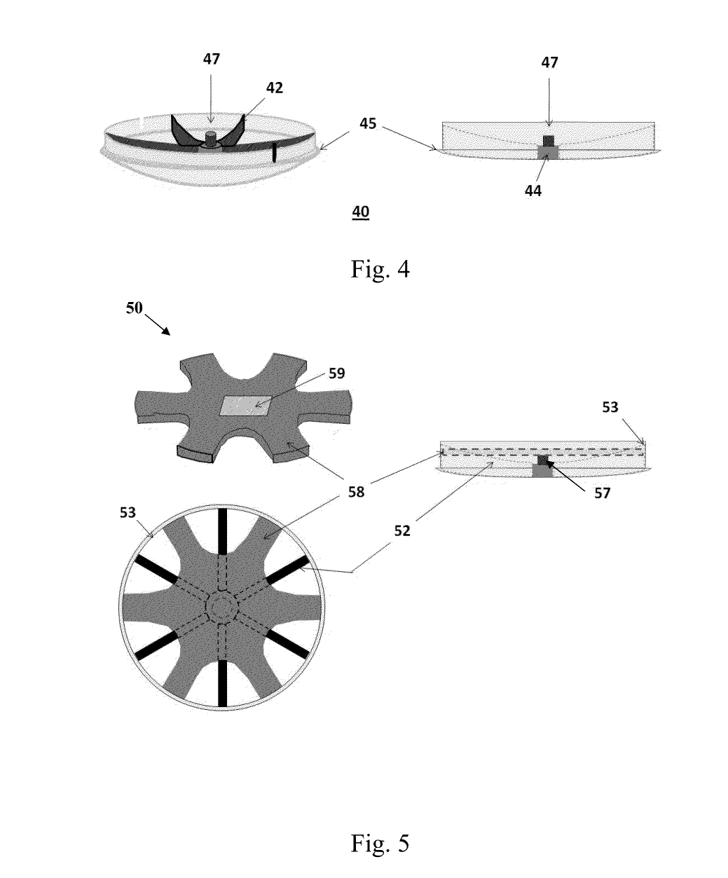

In FIG. 4, the embodiment of FIGS. 2 and 3 is further depicted schematically as view 40, wherein a support post 47 has been added to the hub 44. Post 47 extends vertically out of hub 44 to such a distance as would facilitate supporting a sensor assembly according to subsequent figures provided herein. Support post 47 has a threaded section with which it is affixed to a matching threaded recess tapped into hub 44, as part of the present invention. In one embodiment, the length of post 47 is greater than 0 millimeters and less than 25 millimeters.

In FIG. 5, the embodiment of FIG. 4 of the present invention is further depicted schematically. In the upper left view, a fixture 50 with a stiff elastomer grommet 58 and a microchip/RFID tag assembly 59 is shown in perspective. Microchip/RFID tag assembly 59 is bonded to grommet 58. In one embodiment, grommet 58 has a star shape, with an outer perimeter that is the same as the inside diameter of the inner sleeve 53, so that it may fit into sleeve 53 snugly, preferably without bending, as depicted in the lower left view of FIG. 5. The concave sections of the perimeter of grommet 58, which give it the so-called star shape, are sufficiently sized so that grommet 58 avoids mechanically interfering with the reinforcing ribs 52 when fixture 50 is bonded to post 57 and lying level in the end cap, as depicted in the side view shown in the right hand view of FIG. 5.

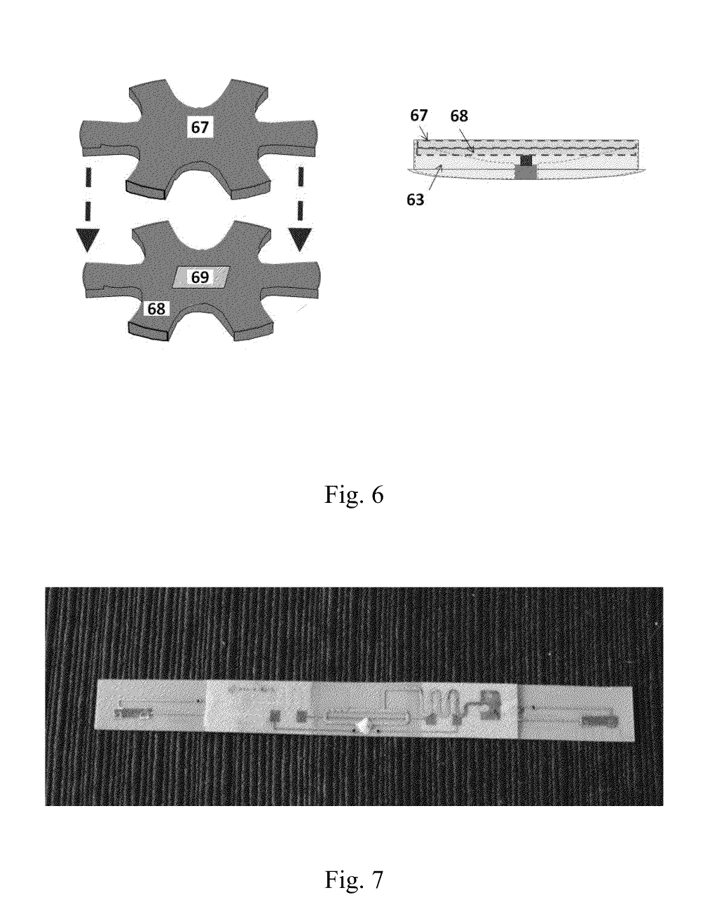

In FIG. 6, the embodiment of FIG. 5 is further depicted schematically. A second grommet 67, which may be identical or substantially identical to first grommet 68, is inserted into end cap 63 and bonded over the top of first grommet 68, and on top of microchip and RFID tag 69, to complete the assembly. Grommet 67 is aligned on top of and attached to grommet 68 to cover and protect microchip and RFID tag 69 and any associated wires. Grommets 67 and 68 fit in such a manner to avoid interference with ribs 63.

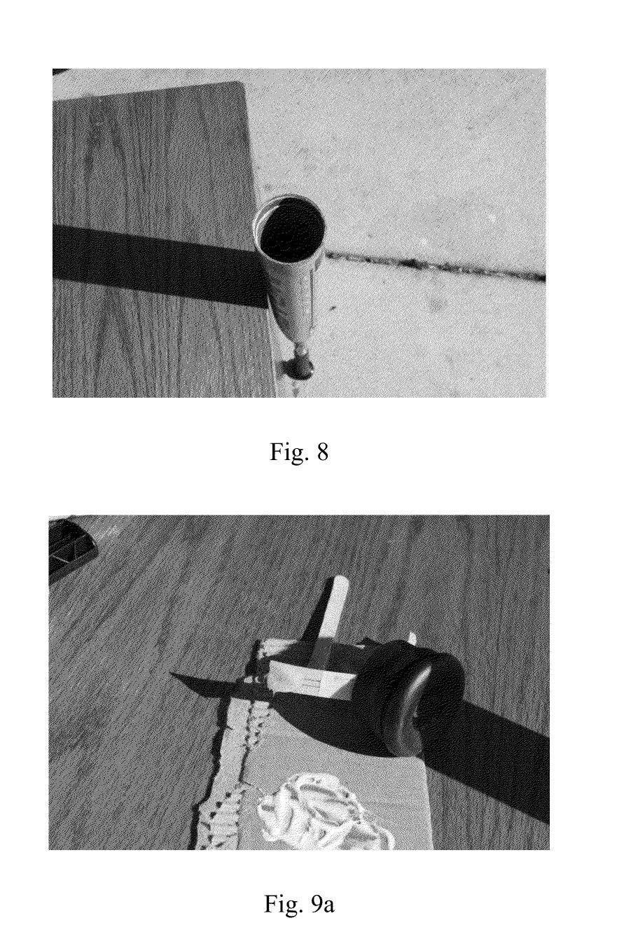

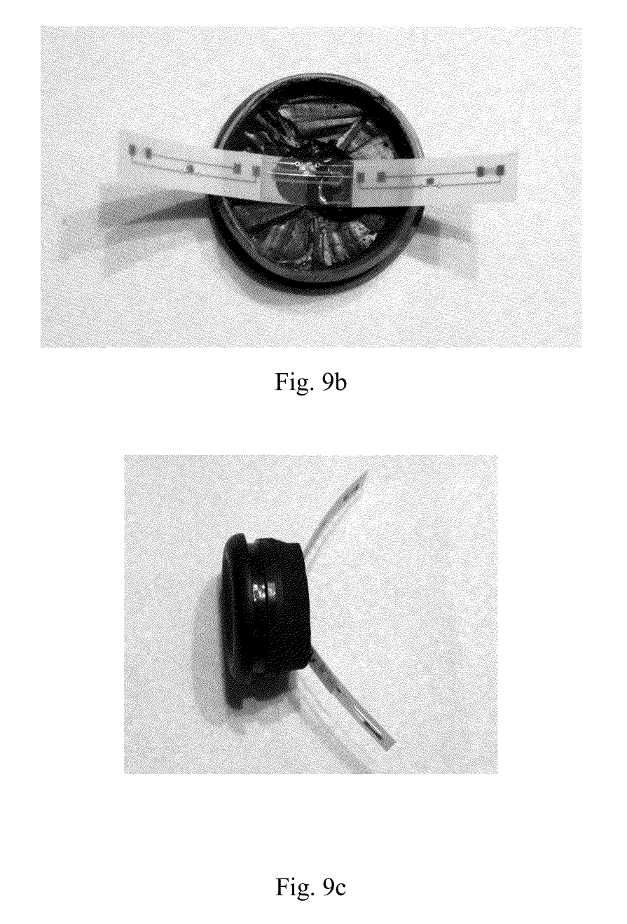

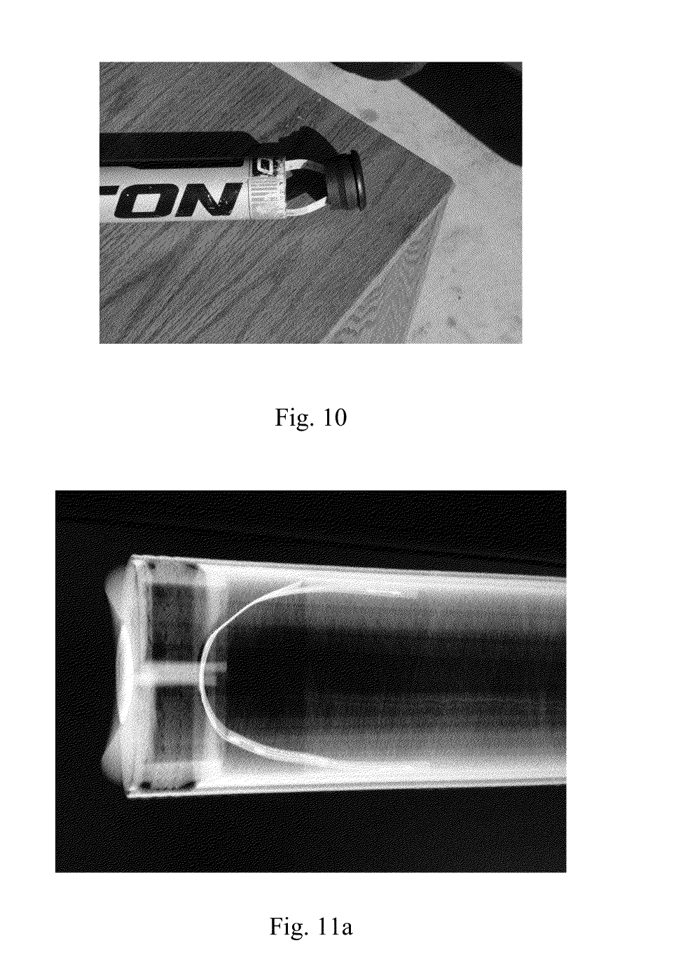

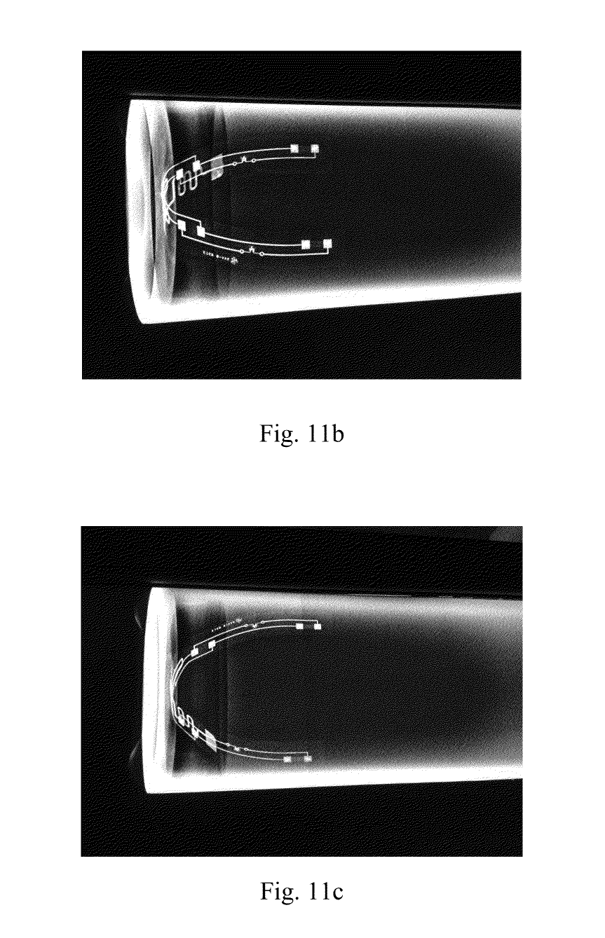

FIGS. 7 through 11a-c, show images of an RFID tag and its integration with a bat. FIG. 7, shows an RFID device 70 with circuitry 71 defined on a long flexible polymer strip 72. FIG. 8 shows a bat 81 with end cap removed. FIGS. 9a, 9b and 9c show attachment and placement of RFID device 70 on end cap 91 Polymer strip 72 of RFID device 70 is bonded approximately at the midpoint of its length, with portions of its length extending beyond end cap 91. In FIGS. 9 and 10, adhesive 91 is added to the portions of strip 72, extended portions 82 of strip 72 are flexed to enable insertion into barrel 30, and the end cap and RFID device are assembled onto the bat. FIG. 10 shows insertion of end cap 91 and attached RFID device 70 into the barrel of bat 81. Adhesive may be applied to the end portions of polymer strip 72 to affix them to the interior wall of bat 81. In FIGS. 11a, 11b, and 11c, show X-ray images of RFID strip 72 within a bat.

It should be appreciated by anyone skilled in the arts of sporting goods manufacture and RFID design that the foregoing are but illustrative examples of the application disclosed in the present invention, and that the application extends to a wide variety of goods in which it is useful to detect the presence of tampering. The scope of the present invention is meant to extend to all such applications, and is accordingly claimed herein as follows.

1. A sports implement comprising:
a body having an internal cavity; and
a signal transmitting device positioned within said internal cavity.

2. The sports implement of claim 1, wherein said body includes a wall, said wall having an internal surface, said internal surface forming a boundary of said internal cavity.

3. The sports implement of claim 2, wherein said wall comprises a metal or a carbon composite material.

4. The sports implement of claim 3, wherein said wall comprises aluminum.

5. The sports implement of claim 2, wherein said internal surface encloses said internal cavity.

6. The sports implement of claim 2, wherein said signal transmitting device is attached to said internal surface.

7. The sports implement of claim 1, wherein said signal transmitting device includes an RFID tag.

8. The sports implement of claim 1, wherein said signal transmitting device includes a kill switch, said kill switch configured to deactivate said signal transmitting device when said body is opened.

9. The sports implement of claim 1, wherein said signal transmitting device is positioned on a polymer substrate.

10. The sports implement of claim 9, wherein said polymer substrate is attached to a boundary of said internal cavity.

11. The sports implement of claim 1, wherein said signal transmitting device includes an antenna.

12. The sports implement of claim 1, wherein said signal transmitting device includes a microchip, said microchip storing information identifying said sports implement or describing the manufacture of said sports implement.

13. The sports implement of claim 1, wherein said signal transmitting device is configured to activate upon receipt of a signal entering said internal cavity from a source external to said body.

14. The sports implement of claim 1, wherein said internal cavity is positioned proximate to an end of said body.

15. The sports implement of claim 1, wherein said sports implement is a bat.

16. The sports implement of claim 15, wherein said bat includes an end cap, said end cap forming a boundary of said internal cavity.

17. The sports implement of claim 16, wherein said signal transmitting device is attached to said end cap.

18. The sports implement of claim 1, wherein said body has an unadulterated state and an adulterated state, said signal transmitting device transmitting a signal when said body is in said unadulterated state, said adulterated state being formed from said unadulterated state upon breach of said internal cavity, said signal transmitting device not transmitting a signal when said body is in said adulterated state.

19. The sports implement of claim 18, wherein said unadulterated state is established at the time of manufacture of said body.

20. A method of detecting tampering of a sports implement comprising:
providing a sports implement, said sports implement including a body having an internal cavity and a signal transmitting device positioned within said internal cavity; and
searching for a signal from said signal transmitting device.

21. The method of claim 20, further comprising providing an interrogating signal, said interrogating signal activating said signal transmitting device.

22. The method of claim 20, further comprising classifying said sports implement, said classifying including providing a first status or a second status for said sport implement, said first status being provided if said signal is detected from said signal transmitting device and said second status being provided if no signal is detected from said signal transmitting device.

23. The method of claim 22, wherein said second status disqualifies said sports implement from use in a sporting contest.

24. A method of modifying a sports implement comprising:
providing a sports implement, said sports implement including an internal cavity; and
placing a signal transmitting device in said internal cavity.

25. The method of claim 24, wherein said placing said signal transmitting device includes exposing said internal cavity.

26. The method of claim 24, wherein said sports implement is a bat.

27. The method of claim 26, wherein said placing said signal transmitting device includes locating said signal transmitting device at the end of said bat.

28. The method of claim 26, wherein said bat includes an end cap and said placing said signal transmitting device includes removing the end cap of said bat.

29. The method of claim 28, wherein said placing said signal transmitting device includes attaching said signal transmitting device to said end cap.
